(19) United States
(12) Patent Application Publication
(10) Pub. No.: US 2008/0013539 A1
(43) Pub. Date: Jan. 17, 2008

(54) DYNAMIC RADIO INTERFACE GROUPING

(75) Inventors: Petteri Poyhonen, Helsinki (FI); Haitao Tang, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/738,360

(22) Filed: Apr. 20, 2007

(30) Foreign Application Priority Data
Jun. 23, 2006 (EP) 06115966.1

(51) Int. Cl. H04L 12/56

(52) U.S. Cl. 370/390

(57) ABSTRACT

A device, comprising a plurality of interfaces (IF-A, IF-B, IF-C) each having an address (MAC-1_{HW}, MAC-2_{HW}, MAC-3_{HW}), a controller configured to define a group of the interfaces, the group including at least one interface, and to define a common logical address (MAC-1_{logical}) for the group.

### CROSS-REFERENCE TO RELATED PATENT APPLICATIONS

The present application claims priority to European Patent Application No. 06 115 966. 1, filed Jun. 23, 2006 and incorporated herein by reference in its entirety.

### FIELD OF THE INVENTION

The present invention relates to a method and a device for configuring connections of interfaces of, e.g., multi-access mobile devices.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Recently, multi-access mobile devices have been developed which are able to connect to different kinds of access networks. For example, such mobile devices may have a function to access a base station of a cellular network, a function to connect to an access point of a wireless local area network (WLAN), etc. Due to the different kind of access networks, these functions are realized by different interfaces. Thus, the mobile device is able to access different kinds of access networks.

However, such a device with multiple available accesses has difficulty to dynamically and effectively utilize the available multiple accesses of the device (e.g., a mobile node (MN)). It becomes even more difficult when some of the available accesses are belonging to different internet service providers (ISP) and/or operators. In addition, handover makes the situation further complicated since in order to effect a handover between two different access networks, a change of the access address (e.g., the multimedia access control (MAC) address of the interface) is necessary. Such a change of an address requires operation load and causes delays.

Thus, according to conventional systems, the benefit of multiple access is limited.

### SUMMARY OF THE INVENTION

Thus, it is an object of the present invention to dynamically and effectively utilize the available multiple accesses of a mobile device.

According to an aspect of the invention, this object is solved by a device, comprising a plurality of interfaces each having an address, a controller configured to define a group of interfaces from the plurality of interfaces, the group including at least one interface, and to define a common logical address for the group.

According to another aspect of the invention, this object is solved by a method, comprising defining a group of interfaces out of a plurality of interfaces each interface having an address, the group including at least one interface mechanism, and defining a common logical address for the group. Thus, it is possible to dynamically group physical interfaces of a mobile device, e.g., according to the surrounding radio access networks and their configuration. Moreover, it is possible to define more than one address for the mobile device, such that the mobile device may use more than one address at the same time.

Furthermore, according to another aspect of the invention, a device is provided which comprises a controller and a sender, wherein the controller is configured to select an address to be used for a packet to be sent to or from a terminal of a plurality of addresses used by the terminal based on weights set for each of the plurality of addresses, and the sender is configured to send the packet.

Alternatively, according to an aspect of the invention a method is provided which comprises selecting an address to be used for a packet to be sent to or from a terminal of a plurality of addresses used by the terminal based on weights set for each of the plurality of addresses, and sending the packet.

Furthermore, according to another aspect of the invention, a device is provided which comprises a controller and a sender, wherein the controller is configured to set different weights for addresses to be used for a packet to be sent to or from a terminal, and the sender is configured to send the packet.

According to a further aspect of the invention, a method is provided which comprises setting weights for each of a plurality of addresses to be used for a packet to be sent to or from a terminal, and sending the packet.

In this way, different weights for a plurality of addresses used by a terminal can be set, and sending of packets to and from the terminal can be controlled based on the weights.

Therefore, a device such as a mobile communication device can be used more efficiently.

According to a further aspect, also a computer program is provided, which comprises code portions by which method aspects of the present invention can be carried out.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the invention are described by referring to the enclosed drawings, in which:

FIG. 1A shows a network structure including a mobile node MN connected to different access networks according to a first embodiment of the invention,

FIG. 1B shows a diagram for explaining a common logical address of interfaces of the mobile node according to the first embodiment,

FIG. 2A shows a network structure including the mobile node MN connected to different access networks according to the first embodiment of the invention,

FIG. 2B shows a diagram for explaining common logical addresses of interfaces of the mobile node according to the first embodiment,

FIG. 3A shows a network structure including the mobile node MN connected to different access networks according to the first embodiment of the invention,

FIG. 3B shows a diagram for explaining common logical addresses of interfaces of the mobile node according to the first embodiment,

FIG. 4 shows a basic structure of a mobile node according to the present embodiment,

FIG. 5 shows a basic flow chart of grouping of interfaces according to the present embodiment,

FIG. 6 shows a basic structure of a home agent of the mobile node according to the present embodiment,

FIG. 7A shows a network structure according to a second embodiment of the invention, and

FIG. 7B shows a diagram illustrating an allocation of care-of addresses to interfaces according to the second embodiment.

### DETAILED DESCRIPTION OF VARIOUS EMBODIMENTS

In the following, embodiments of the present invention is described by referring to the attached drawings.

According to embodiments of the present invention described in the following, a multi-access mobile device may dynamically group its physical interfaces according to the surrounding radio access networks and their configuration. Radio interfaces connected under the same internet protocol (IP) topology are automatically grouped under the same IP address. Optionally, a local functionality may exist in mobile device, which should be able to detect whenever a grouped radio interface makes a handover to a new radio access network that is not under the same IP topology as other grouped interfaces resulting radio interface regrouping.

In the following, a first embodiment is described in more detail. As described above, according to the embodiment, a multi-access mobile device (e.g., a mobile node (MN)) may dynamically group its physical interfaces according to surrounding radio access networks and their configuration.

An application in the mobile node can then use one or more available accesses to communicate with an application in the Internet. This method works as the following.

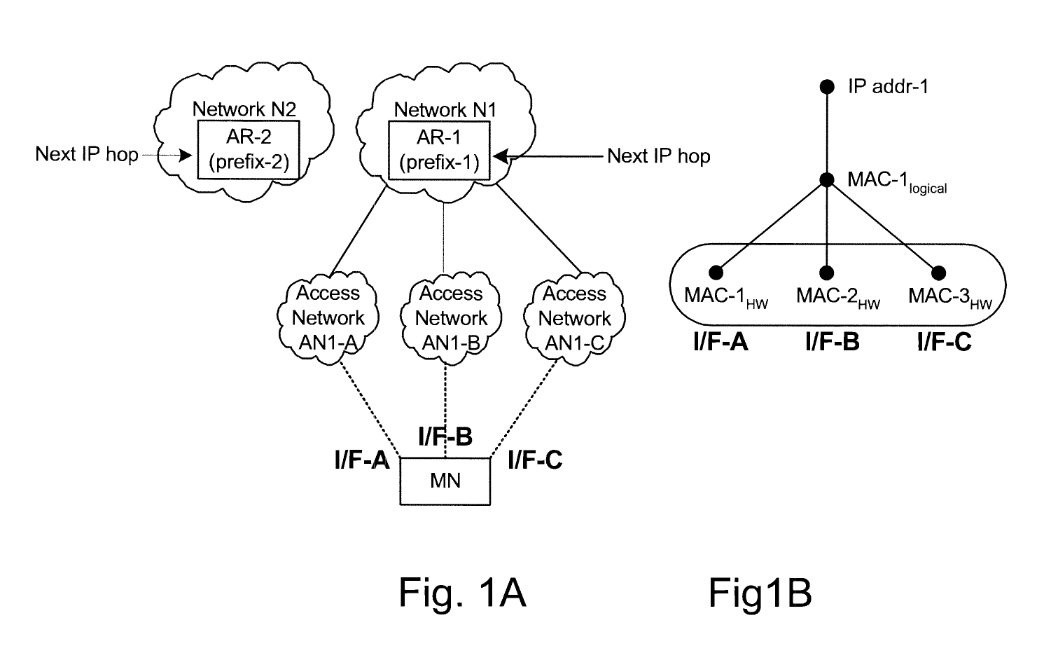

FIG. 1A shows a first example in which a mobile node (MN) comprises three interfaces I/F-A, I/F-B and I/F-C. These interfaces are each connected to access networks AN1-A, AN1-B and AN2-C. The access networks are access networks for a single network N1. This network N1 comprises an access router (AR) AR1. Furthermore, a second network N2 is illustrated, which also comprises an access router (AR) AR2.

Thus, FIG. 1 illustrates how the mobile nodes radio interfaces (I/F-A, I/F-B and I/F-C) are all attached to different radio access networks (AN1-A, AN1-B, AN1-C) that are provided by a single service provider, e.g., by the operator of network N1. The service provider's all radio access networks are configured to share the same IP network prefix that is provided by the access router (AR-1).

This makes it possible to group all three radio accesses under a single internet protocol (IP) address via a logical address, such as a media access control (MAC) address. The mobile node has configured this address as presented in FIG. 1B. In particular, the interface I/F-A has the MAC address MAC-1HW, the interface I/F-B has the MAC address MAC-2HW, and the interface I/F-C has the MAC address MAC-3HW. The mobile node has configured the common logical address MAC-1_{logical} for all three interfaces. To this common logical address, the internet protocol address IP addr-1 is assigned on the network layer (Layer 3).

In this case, IP layer is not aware of the use of multiple physical radio access technologies. That is, when the mobile node MN detects that all of the attached accesses share the same logical MAC address at the network side, the mobile node MN activates also its own logical MAC entity to hide the multiple actual accesses from its IP entity (IP layer). Hence, the IP entity at the network side seems communicating with the IP entity at the mobile node side over one logical link, while the logical link in this case consists of one or more physical links and this logical link entity takes care-of the actual scheduling of sending the frames over the available physical links.

The IP entity at the network side updates the mobile node's home agent with the care-of IP address (IP addr-1 in the example of FIG. 1B) and the home IP address of the mobile node. An application in the Internet can thus communicate with the application in the mobile node.

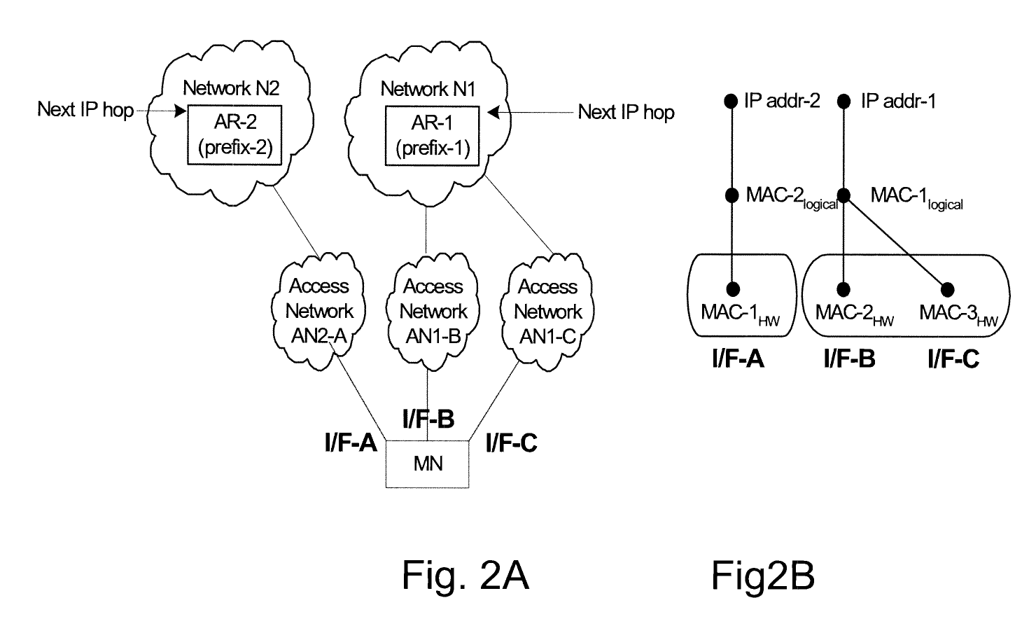

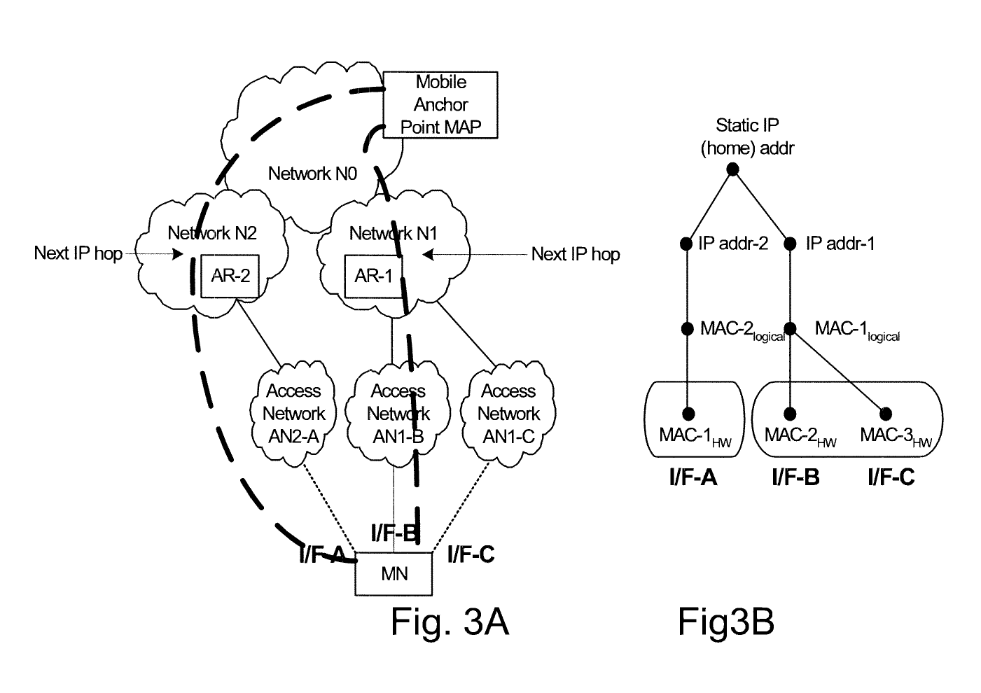

In FIGS. 2A-3B, examples are shown in which the mobile node is attached to more than one operator network, namely to the first network N1 and to the second network N2, which is already shown in FIG. 1A.

FIG. 2A shows an example in which the mobile node MN has performed a handover for its I/F-A to the network N2. In particular, after association has been re-established to a new radio access network A2-A, the mobile node detects that the used prefix (Prefix-2) is different from the one used for the interfaces I/F-B and I/F-C, and therefore a radio interface regrouping is triggered. After successful regrouping, the interface I/F-A has optionally a new logical MAC (MAC-2_{logical}) and a new IP address (IP addr-2). This is a configuration change on the network layer or layer 3 (L3). The mobile node MN may perform this layer 3 (L3) configuration change for example based on a received router advertisement message that is sent by the access router AR-2 of the network N2 to advertise supported network prefixes (prefix-2). Alternatively, the mobile node MN may use dynamic host configuration protocol (DHCP) to configure its new IP address under the prefix-2.

This is illustrated in FIG. 3B. To the interface I/F-A having the hardware address MAC-1_{HW}, the logical address MAC-2_{logical} is assigned to, and to the new IP address

IP addr-2 is assigned to this new logical address MAC-2_{logical}. The remaining interfaces I/F-B and I/F-C having the MAC addresses MAC-1_{HW} and MAC-3_{HW}, the common logical address MAC-1_{logical} is assigned, respectively, as in the example of FIG. 1B.

Hence, due to the handover of one of the physical links towards another ISP/operator network, the mobile node detects that all the accesses used to access the Internet share more than one logical MAC addresses at the network side. The mobile node assigns its logical MAC entities (two in this case) accordingly. The mobile node also acquires another IP address from the newly handovered network. The mobile node has now two IP addresses (i.e., care-of addresses (CoA)).

The IP entity of the newly handovered network may update the newly assigned IP address (the CoA) to its mobile anchor point (MAP) like home agent. This is illustrated in FIGS. 3A and 3B.

The illustration in FIG. 3A is similar to that of FIG. 2A, whereas an additional network NO is shown in the mobile anchor point (MAP) is located. The mobile anchor point acts like a home agent of the mobile node, so alternatively the mobile anchor point shown in FIG. 3A may also be the home agent itself or another suitable network element.

Thus, the home address of the mobile node is now bound to these two care-of addresses. It is the mobile node and its home agent of the mobile node to do the actual scheduling of the packets to send over the two available IP interfaces. The application in the Internet can continue to communicate with the application in the mobile node through the home address of the mobile node. mobile anchor point may vary depending on the used mobility management mechanisms. After the handover, when regrouping of interfaces is done, mobile node needs to detect the need to notify its home agent about new care-of address (CoA).

Thus, according to the present embodiment, the mobile node may have multiple active care-of addresses (CoAs) that are used parallel to send traffic back to the mobile node. The mobile node is aware of its own link conditions and related IPs and therefore they can adjust active set of care-of addresses accordingly.

Moreover, different care-of addresses (CoAs) may use different weights. That is, the care-of address with higher weight value may be used more than another care-of address with lower weight value. It is noted that this distribution depends on definition, so that alternatively a care-of address with lower weight value may be used more that a care-of address with a higher weight value.

So basically, the mobile node is able to adjust what care-of addresses are used and how much traffic is transferred over them. By adjusting the weight value of care-of addresses, the mobile nodes are able to manage how related radio links are used.

In this connection, it is noted that concerning the weights described above, it has to be distinguished between 1) assigning/creation of weights and 2) usage of weights (i.e., transfer of traffic according to the weights).

Regarding 1), different alternatives are that only the mobile node assigns/creates weights, or that only the mobile anchor point (or the home agent) assigns/creates weights, or that both assign/create weights.

Regarding 2), the different alternatives are that only the mobile node uses the weights, that only the mobile anchor point (or the home agent) uses the weights, or that both use the weights. These two are independent on each other in the sense that if for example only mobile node assigns/creates weights, it might then inform the mobile anchor point acts like a home agent, which would then only use them.

The different weight usage scenarios might result asymmetric traffic flow, i.e. different CoAs are used for upstream and downstream packets. Also, sometimes it might be that the network (e.g., the mobile anchor point or the home agent) dictates how and what weights are used.

In a simple example, it is assumed the mobile node comprises a set of active care-of addresses with the same weight value. Now the home agent would basically follow round-robin approach to transfer traffic to the mobile node by using each such care-of address one at the time.

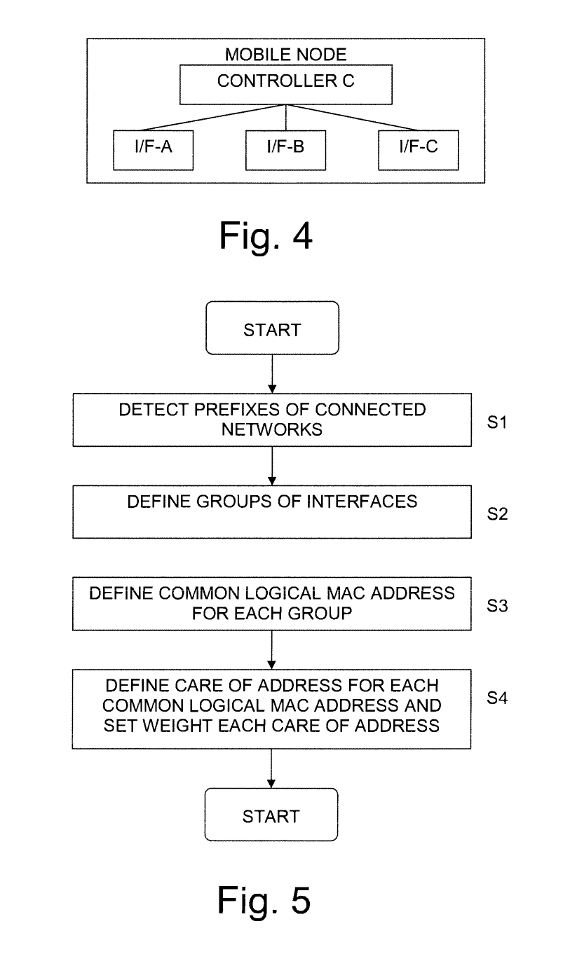

In FIG. 4, the basic configuration of a mobile node is shown. It is noted that FIG. 4 only the basic elements as described above are shown in order to simplify the drawing.

As described above, the mobile node comprises the interfaces I/F-A, I/F-B and I/F-C, for example. The number of interfaces is not limited, three is only taken as an example. The interfaces may support different kinds of radio access technologies, however, there may be also interfaces supporting the same radio access technology. In this case, the corresponding interfaces could be connected to different access networks of the same radio access technology (For example, in FIG. 2A the interfaces I/F-A and I/F-B may both support wireless local area network (WLAN)). A weighting of the care-of addresses may then be set based on the connection quality or the like.

Moreover, the mobile node comprises a controller MN-C. The controller may include a CPU and different kinds of memory such as RAM, ROM, a hard disk, a CD ROM reader or the like. A computer program may be stored in the memory and may comprise software code portions for carrying out the method according to the embodiments. This computer program may be stored on a recording medium such as a CD ROM, for example, and may be directly loadable into the work memory of the controller. Alternatively, the computer program may be loaded via the network into the memory of the controller.

In the following, the procedure according to the present embodiment is summarized by referring to FIG. 5. In particular, FIG. 5 shows a flow diagram for configuring a group of interfaces, i.e., to set a common logical address for the group of interfaces.

At S1, network prefixes supported by the network (e.g., network N2 in FIG. 1A) are detected. As mentioned above, this may be carried out by receiving a router advertisement message sent from the access router of the network.

At S2, the group is defined. In particular, it is checked which interfaces may be allocated to the same subnet.

At S3, a common logical address is defined for each group. In FIG. 1B, there is only one group, whereas in FIGS. 2B and 3B, two groups are present.

Moreover, at S4, the care-of addresses are set and optionally, weights may be defined for the care-of addresses, as described above.

The process mentioned above can be carried out each time the interfaces are started to be used and/or also each time a handover of one of the interfaces is detected. The controller comprises therefore a functionality to detect a handover of one of the interfaces.

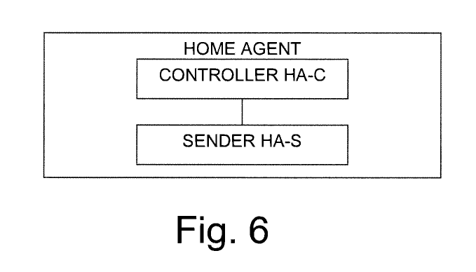

FIG. 6 shows an example for a home agent of the mobile node. It is noted that this may be the MAP shown in FIG. 3A or another suitable network element. The home agent comprises a controller HA-C, which basically may have the same structure as the controller of the mobile node, i.e., may comprise a CPU, several memories and the like. Moreover, also in this controller a corresponding computer program may be loaded.

The controller HA-C decides which route is to be taken for a packet to be sent to the mobile node in case the mobile node uses more than one care-of address at the same time (e.g., IP addr-1 and IP addr-2). As mentioned above, different weights may be allocated to the different care-of addresses, so that the route, i.e., the care-of address to be used, is selected based on the weight of the care-of address.

The device further comprises a sender HA-S by which the packets destined for the mobile node are sent via the network.

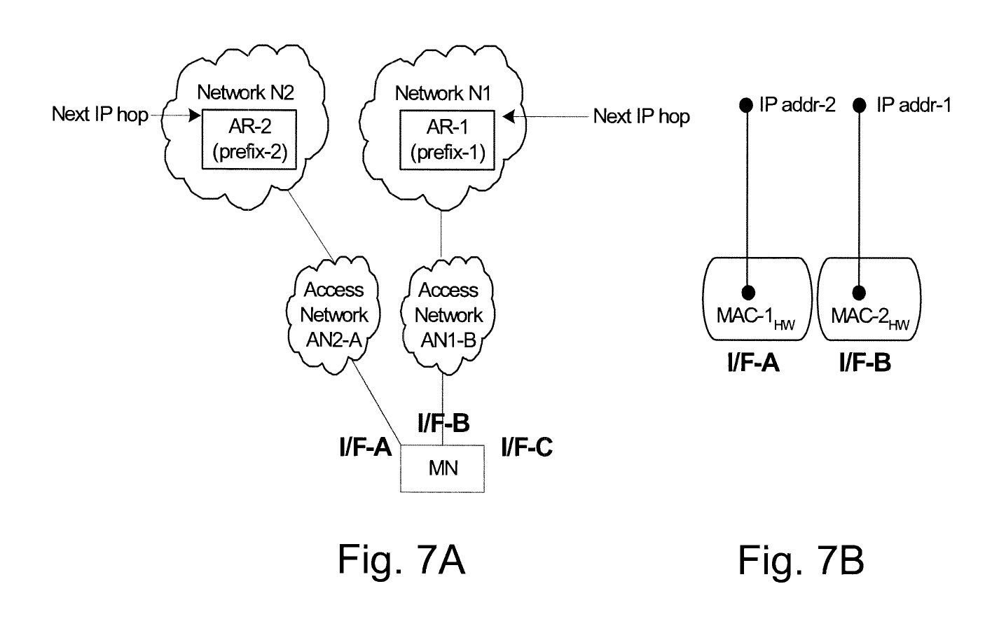

In the following, a second embodiment is described. The second embodiment is the same as the first embodiment described above with the exception that no common logical MAC addresses are defined, but that the care-of addresses are assigned to each interface. That is, according to the second embodiment, a group of interfaces as described in the first embodiment has only one interface. This is shown in FIGS. 7A and 7B. Here, the interface I/F-A is allocated the care-of address IP addr-2, and to the interface I/F-B is allocated the care-of address IP addr-1. The remaining elements are similar as those shown in FIGS. 2A and 2B.

Thus, the mobile node may use two care-of addresses at the same time. Similar as according to the first embodiment, different weights can be set for the care-of addresses. Hence, the home agent or MAP can select the route to be taken by a packet in the same as described in connection with FIGS. 3A and 3B according to the first embodiment.

The invention is not limited to the embodiments described above. For example, the embodiments may be combined. That is, for example, for one network no common logical MAC address is created, whereas for another network there is. That is, in the example of FIG. 2A, the common logical address MAC-2_{logical} for the second network N2 may be omitted and instead the hardware MAC address MAC-1_{HW} may be used. Furthermore, it is noted that MAC can be replaced by any other sufficient link layer mechanisms.

In the embodiments described above, only physical addresses of interfaces were grouped. However, it is also possible to allow grouping of logical addresses, which would add another level of hierarchy. Thus, according to these alternative embodiments, optionally, a local functionality may exist in the mobile device, which supports grouping of logical interfaces. For example, FIG. 3B also presents a case example of grouping logical addresses. Namely, the static home IP address of the IP device groups the multiple CoAs of this IP device.

Furthermore, in the above embodiments, a single access router is used in each network. However, the invention is not limited thereon. For example, in FIGS. 1A, 2A and 3A more than one access router may be used in the first network N1, as long as all IP addresses are allocated from the same subnet.

Moreover, in case the operator of the first network N1 would use different access networks with addresses allocated to different subnets, then the mobile node could group the interfaces based on the different subnets.

In the above embodiments, it was described that the mobile node sets the weights of the care-of addresses, e.g., according to the link conditions. However, alternatively this could also be effected by the home agent or the mobile anchor point, for example.

According to several embodiments, a device may be provided which comprises a controller and a sender, wherein the controller is configured to select an address to be used for a packet to be sent to or from a terminal of a plurality of addresses used by the terminal based on weights set for each of the plurality of addresses, and the sender is configured to send the packet.

The controller may be configured to set weights for each of the plurality of addresses. For example, the controller is configured may set the weights based on link conditions. The device may be a network control node or may be a terminal such as the terminal described above.

According to several embodiments, a method may be provided which comprises selecting an address to be used for a packet to be sent to or from a terminal of a plurality of addresses used by the terminal based on weights set for each of the plurality of addresses, and sending the packet.

The above method may further comprise setting weights for each of the plurality of addresses. For example, the weights may be set based on link conditions.

The mobile node is only an example for a device having a controller and interfaces. Instead, any device having interfaces may be used. For example, the device may also be a fixed network node having different network interfaces for a fixed network connection.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A device, comprising:
a plurality of interfaces each having an address, and
a controller configured to:
define a group of interfaces, the group including at least one interface from the plurality of interfaces, and
define a common logical address for the group.

2. The device according to claim 1, wherein the at least one interface supports different radio access technologies.

3. The device according to claim 1, wherein the controller is configured to define a plurality of groups, each having a common logical address.

4. The device according to claim 1, wherein the controller is configured to define the group of interfaces based on subnet addresses of corresponding access networks.

5. The device according to claim 1, wherein the controller is configured to detect a handover of an interface and to regroup the interfaces in response to the detection of a handover.

6. The device according to claim 1, wherein the common logical address is defined on the data link layer, and for each common logical address, an address is defined on the network layer.

7. The device according to claim 6, wherein the controller is configured to set different weights for the addresses.

8. The device according to claim 6, wherein the controller is configured to control traffic based on different weights for the addresses.

9. The device according to claim 3, wherein the controller is configured to define the groups such that each group includes one single interface.

10. The device according to claim 9, wherein the common logical address allocated to each group is an address on the network layer.

11. The device according to claim 10, wherein the controller is configured to set different weights for the addresses.

12. The device according to claim 9, wherein the controller is configured to control traffic based on different weights for the addresses.

13. The device according to claim 7, wherein the controller is adapted to set the different weights for the addresses based on link conditions.

14. The device according to one of the claims 1, wherein the addresses of the interfaces are selected from the group consisting of fixed hardware addresses and network addresses.

15. A method, comprising:
defining a group of interfaces out of a plurality of interfaces each interface having an address, the group including at least one interface, and
defining a common logical address for the group.

16. The method according to claim 15, wherein the at least one interface supports different radio access technologies.

17. The method according to claim 15, further comprising
defining a plurality of groups each having a common logical address.

18. The method according to claim 15, further comprising
defining the group of interfaces based on subnet addresses of corresponding access networks.

19. The method according to claim 15, further comprising:
detecting a handover of an interface and
regrouping the interfaces in response to the detection of a handover.

20. The method according to claims 15, further comprising:
defining the common logical address on the data link layer, and
defining, for each common logical address, an address on the network layer.

21. The method according to claim 20, further comprising
setting different weights for the addresses.

22. The method according to claim 20, further comprising
controlling traffic based on different weights for the addresses.

23. The method according to claim 17, further comprising
defining the groups such that each group includes one single interface.

24. The method according to claim 23, wherein the common logical address allocated to each group is an address on the network layer.

25. The method according to claim 24, further comprising
setting different weights for the addresses.

26. The method according to claim 24, further comprising
controlling traffic based on different weights for the addresses.

27. The method according to claim 21, further comprising
setting the different weights for the addresses based on link conditions.

28. The method according to claim 15, wherein the addresses of the interface are selected from the group consisting of fixed hardware addresses and network addresses.

29. A device, comprising:
a controller and
a sender,
wherein the controller is configured to set different weights for addresses to be used for a packet to be sent to or from a terminal, and
wherein the sender is configured to send the packet.

30. The device according to claim 29, wherein the controller is configured to set the weights based on link conditions.

31. The device according to claim 29, wherein the controller is configured to select an address for a packet to be sent to the terminal of a plurality of addresses used by the terminal based on the weights set for each of the plurality of addresses.

32. The device according to claim 29, wherein the device is one of a network control node and the terminal.

33. A method, comprising:
setting weights for each of a plurality of addresses to be used for a packet to be sent to or from a terminal, and
sending the packet.

34. The method according to claim 33, further comprising setting the weights based on link conditions.

35. The method according to claim 33, further comprising
selecting an address for a packet to be sent to a terminal of the plurality of addresses used by the terminal based on the weights set for each of the plurality of addresses.

36. A computer program product for a computer, embodied in a computer-readable medium, comprising software code portions for performing the steps of claim 15.

37. The computer program product according to claim 36, wherein the computer program product is directly loadable into an internal memory of the computer.

38. The computer program product according to claim 36, wherein the computer is incorporated in a controller of a network node.

39. A computer program product for a computer, embodied in a computer-readable medium, comprising software code portions for performing the steps of claim 33.

40. A device, comprising:
a plurality of interface means each having an address, and
means for defining a group of interface means, the group including at least one interface means from the plurality of interface means, and
means for defining a common logical address for the group.

41. A device, comprising:
means for setting different weights for addresses to be used for a packet to be sent to or from a terminal, and
means for sending the packet.
